(19) United States
(12) Patent Application Publication
(10) Pub. No.: US 2005/0254912 A1
(43) Pub. Date: Nov. 17, 2005

(54) Double ended cutting tool

(76) Inventor: Edward J. Skrzynski, Lake Worth, FL (US)

Correspondence Address: KENNAMETAL INC., P.O. BOX 231, 1600 TECHNOLOGY WAY, LATROBE, PA, 15650, US

(21) Appl. No.: 10/847,568

(22) Filed: May 17, 2004

(51) Int. Cl. B23B 51/00

(52) U.S. Cl. 408/226

(57) ABSTRACT

A two ended reversible tool holder for a machine tool. At least one end and optionally both ends each have at least one seat or pocket for receiving a repositionable blade such as an indexable insert. The tool holder may be bilaterally symmetrical wherein both ends comprise similar tools, or alternatively, may have dissimilar ends. If dissimilar, both ends may still have seats or pockets for receiving repositionable blades. Other than that end having one or more seats for blades, the remaining end may have a different pocket arrangement, or optionally may comprise a bit holder such as a collet chuck, an integral twist drill, a combination of bladed tools such as inserts combined with a centrally located twist drill, may comprise still other cutting tools, or may differ in rotational handedness orientation.

### BACKGROUND OF THE INVENTION

1. Field of the Invention

The present invention relates to cutting tools of the type mountable in a machine tool, and more particularly to cutting tools which are double or two ended in the sense of being reversible, and which accept interchangeable cutting elements such as, in a preferred embodiment, indexable cutting inserts.

2. Description of the Related Art

Milling tools have long been known for use with machine tools. A typical milling tool has a shank which is received in and removably fixed to the chuck or socket of the machine tool. The milling tool typically has a cutting blade at that end of the shank which is opposite the end received in the machine tool. The cutting blade may either be integral with the milling tool, or alternatively may be of the replaceable type including those known in the industry as inserts. Inserts and other replaceable blades greatly lower machining costs since when they are worn out or damaged, only the insert or blade need be replaced. The cutting tool itself may be provided with new inserts or blades and thus may be reused for a prolonged period of time. Repositionable blades, especially those known as inserts, also enjoy extended use by virtue of their design. Particularly considering inserts, most inserts are configured to present cutting edges at different surfaces thereof, and to be positioned relative to the cutting tool. Illustratively, an insert may be removed from a cutting tool, rotated by one hundred eighty degrees, and reinstalled within the cutting tool. Thus the insert need not be discarded when one cutting surface thereof is no longer serviceable, thereby extending the useful life of the insert and further reducing machining costs. U.S. Pat. No. 5,882,150, issued to Furuta et al. on Mar. 16, 1999, illustrates an indexable end mill which is representative of milling tools bearing repositionable inserts. In a further development of reduced costs of machine tools, cutting tools have been designed to be reversibly mounted in associated machine tools. To this end, the cutting tool is typically bilaterally symmetrical about its length, having a cutting head at one end and another cutting head at the opposed end. Such a tool may be installed in a machine tool, and subsequently removed, reversed, and reinstalled, such as when one end is worn out or damaged. This approach is shown in U.S. Pat. No. 2,104,267, issued to Melin on Jan. 4, 1938, U.S. Pat. No. 2,609,209, issued to Perman on Sep. 2, 1952, and U.S. Pat. No. 4,902,177, issued to Burnett on Feb. 2, 1990. The subject devices of Melin, Perman, and Burnett have shanks with opposed cutting ends, but little in the way of central attachment structure for cooperating with a machine tool. A reversible tool may have enlarged central attachment structure for cooperating with a machine tool, as seen in U.S. Pat. No. 5,810,102, issued to Stewart on Sep. 22, 1998. A reversible tool may have a replaceable cutting blade, as shown in U.S. Pat. No. 336,762, issued to Smith on Feb. 23, 1886. However, these beneficial features are provided piecemeal in prior art practice. There remains a need for a cutting tool usable with contemporary machine tools, which cutting tool is two ended and thus reversible, and which repositionably receives blades such as for example inserts which are reversible within their respective pockets or are otherwise repositionable on the cutting tool.

### SUMMARY OF THE INVENTION

The present invention answers the forementioned need by providing a cutting tool which both repositionably receives cutting inserts and also is two ended in the sense of being reversible. The cutting tool has an elongated body wherein one cutting head is formed at one end, and a second cutting head is formed at the opposed end. At least one, and in some embodiments both cutting heads have at least one seat for receiving a repositionable cutting blade, and optionally a plurality of such seats. In a preferred embodiment, the seats are pockets formed in flutes inscribed along the elongated body of the cutting tool, and the blades are indexable inserts. In a further preferred embodiment, the cutting tool has a central attachment structure located on the body between the two cutting heads. The central attachment structure comprises a generally cylindrical member of diameter greater than those of the cutting heads, and preferably has at least one flat facet formed in the outer surface of the cylindrical surface, for seating setscrews or other securement devices of the machine tool.

It is therefore an object of the invention to further improve efficiency of machine tools by combining the concepts of reversibility and of use of repositionable blades in one cutting tool usable with machine tools.

### BRIEF DESCRIPTION OF THE DRAWINGS

Further features of the present invention, as well as the advantages derived therefrom, will become clear from the following detailed description made with reference to the drawings in which:

FIG. 1 is a perspective view of one embodiment of the invention.

FIG. 2 is a side elevational view of a second embodiment of the invention.

FIG. 3 is a side elevational view of a third embodiment of the invention.

FIG. 4 is an exploded side elevational view of a fourth embodiment of the invention, shown partially in cross section.

FIG. 5 is a side elevational view of a fifth embodiment of the invention.

FIG. 6 is a side elevational view of a sixth embodiment of the invention.

### DESCRIPTION OF THE PREFERRED EMBODIMENTS

The present invention is a double ended or reversible cutting tool intended for use with a machine tool (not shown) typically including a rotatable element capable of rotating the novel double ended cutting tool while bearing against a work piece (not shown). The type of machine tool is not important to the invention in that the cutting tool may be rotated while the work piece is held stationary, the work piece may be rotated while the cutting tool is held stationary, or both the cutting tool and also the work piece may be rotated. Of course, other patterns of mutual motion may be substituted for rotation where appropriate. The essence of the invention is the combination of a double ended or reversible cutting tool together with the characteristic that at least one end has at least one seat or pocket which receives a cutting blade such as an indexable insert. The remaining end may also receive repositionable cutting blades such as inserts or alternatively may have other types of cutters. It should further be understood that the cutting heads, or those ends of the cutting tool which bear blades or cutting surfaces may be of any known type as well as of novel types which cooperatively receive and retain cutting tools.

As employed herein, the term “indexable” signifies that each seat and blade, such as a pocket and insert, are configured and dimensioned such that the blade is configured to be received in a pocket both in a first orientation relative to that pocket and also in a second orientation relative to that pocket in a manner enabling a different cutting edge of the insert to be exposed to a work piece. This is a conventional characteristic of indexable inserts, and need not be further described herein. In any cutting tool according to the present invention, there is at least one such seat or pocket capable of receiving a blade such as an indexable insert.

Specific embodiments of the invention will now be described.

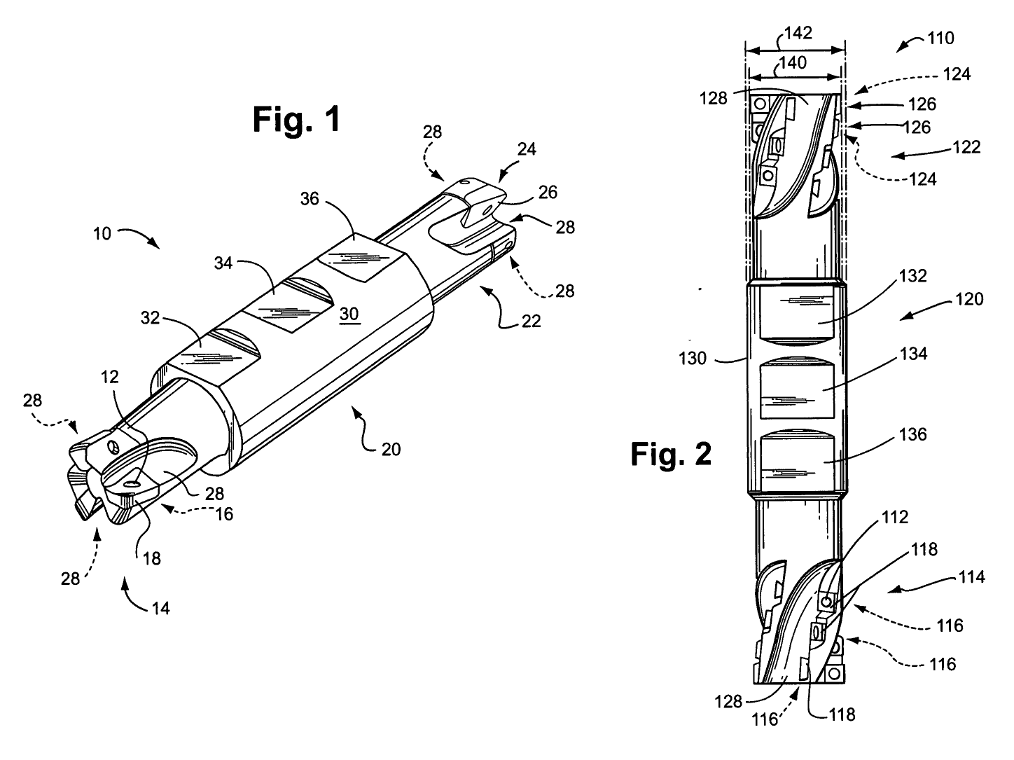

FIG. 1 shows one embodiment of a double ended cutting tool 10 which comprises an elongated body having a first end section including a first cutting head 14 having three pockets (exemplified by pocket 16) formed therein for receiving and retaining an insert 18, a second end section located oppositely from the first end section, and a central connector 20 located between the first and second end sections. Insert 18 is conventionally retained by a fastener configured to captively engage insert 18, preferably a threaded fastener such as screw 12. Of course, pocket 16 includes a threaded opening (not shown) for receiving screw 12, which is threadably engageable with the threaded opening. In other embodiments, other retention schemes are possible. For example, clamps to be described hereinafter are used in some embodiments.

Central connector 20, which is centrally located between the first and second end sections, serves to enable attachment of cutting tool 10 to a chuck or other interface element of the machine tool. In the embodiment of FIG. 1, the end sections are visually distinct from central connector 20. However, the term “end section” is employed herein for semantic convenience and clarity of understanding only. End sections in other embodiments may possibly not be discernible from the connectors of those other embodiments.

A second cutting head 22 is located and is oriented opposite cutting head 14. Cutting head 22 also has pockets (exemplified by pocket 24). Each pocket receives an indexable insert (exemplified by insert 26). The inserts used in cutting tool 10 are similar to one another in the embodiment of FIG. 1, and are retained by screws similar to screw 112. Cutting tool 10 is a double ended end milling tool displaying the same handedness on each end, or alternatively stated, is configured to bring a cutting edge of each insert (e.g., insert 18 or insert 26) to bear on a work piece when the machine tool is operated in the same rotational direction regardless of which cutting head 14 or 22 is exposed to the work piece and which is in an inoperative position within the machine tool.

Cutting heads 14 and 16 are generally conventional, each having a plurality of flutes 28. Each flute 28 has one pocket (such as pocket 16 or pocket 24). In the embodiment of FIG. 1, each cutting head 14 or 16 has three flutes 28 evenly staggered about the circumference at one hundred twenty degree intervals.

Central connector 20 is also generally conventional, having an engagement surface disposed to engage the drive element of the machine tool in a manner preventing mutual rotation between cutting tool 10 and the drive element of the machine tool. In most cases, the drive element is rotary, in that it imparts rotation to cutting tool 10. However, other motions, such as linear and elliptical, are possible. It is further possible that cutting tool 10 be held in a fixed position, with motion being imparted to the work piece, as occurs in a lathe (not shown). In the latter case, the drive element will be understood to encompass apparatus (not shown) for securing cutting tool 10 or its equivalent to the machine tool. In the embodiment of FIG. 1, this structure includes an exterior circumferential surface 30 and three flat facets 32, 34, 36 machined into surface 30. Facets 32, 34, 36 are formed in a straight row and are spaced apart from one another along surface 30 in the embodiment of FIG. 1.

FIG. 2 shows a second embodiment of the invention which is generally similar to that of FIG. 1, but differs in that cutting heads 114, 122 of cutting tool 110 are longer than their counterparts of cutting tool 10 of FIG. 1 to accommodate plural pockets 116 or 124 formed in each flute 128. Each pocket 116 or 124 receives one insert 118 or 126.

In the embodiment of FIG. 2, connector 120 is essentially similar to its counterpart of cutting tool 10 of FIG. 1, having an exterior circumferential surface 130 modified to include flat facets 132, 134, 136. Also in common with cutting tool 10 is that facets 132, 134, 136 are formed in a straight row and are spaced apart from one another along surface 130 in the embodiment of FIG. 2. It is preferable yet not critical to either embodiment that separate facets 32, 34, 36 or 132, 134, 136 be separate. In a possible alternative to both embodiments, a single long facet or two spaced apart facets (neither embodiment is shown) may be provided if desired.

The side elevational view of FIG. 2 reveals a further optional yet preferable characteristic of the embodiment of FIG. 2. That is, first and second end sections or cutting heads 114, 122 have a maximum diameter 140 which is of magnitude less than the maximum diameter 142 of connector 120. This characteristic facilitates axial insertion or movement of the first and second end sections of cutting tool 110 through the rotatable drive element, such as the chuck, of a machine tool. Insertion without making interfering contact with the rotatable drive element is more easily accomplished. The rotatable drive element of the machine can radially close over and retainingly engage central connector 120 of cutting tool 120. Because both ends of cutting tool 110 are symmetrical, and in view of lesser diameter of the two ends, reversible installation of cutting tool 110 within the machine tool is readily accomplished.

It will further be noted that each of the connectors 20, 120 of cutting tools 10, 110 exceeds the respective connectors 20, 120 in length. This is a preferred compact configuration, but is not essential. In other embodiments, this relationship will not hold true.

Each of the first end section and the second end section of cutting tools 10, 110 has a cutting head 14, 22 or 114, 122. In the embodiments of FIGS. 1 and 2, each cutting head 14, 22 or 114, 122 is one type of cutting implement which may be provided according to the invention. In the embodiment of FIG. 1, the two cutting implements are essentially similar, each being a fluted tool holder having pockets essentially similar to pocket 16 formed in each flute 28. The embodiment of FIG. 2 is similar, except that every flute 128 has a plurality of pockets 116 or 124. In other embodiments, other types of cutting implements may be provided. More specifically, a cutting implement may be any of the group including a cutting head having at least one pocket formed therein for receiving and retaining an insert, as seen in the embodiments of FIGS. 1 and 2, or alternatively may be a cutting blade or a cutting tool retainer.

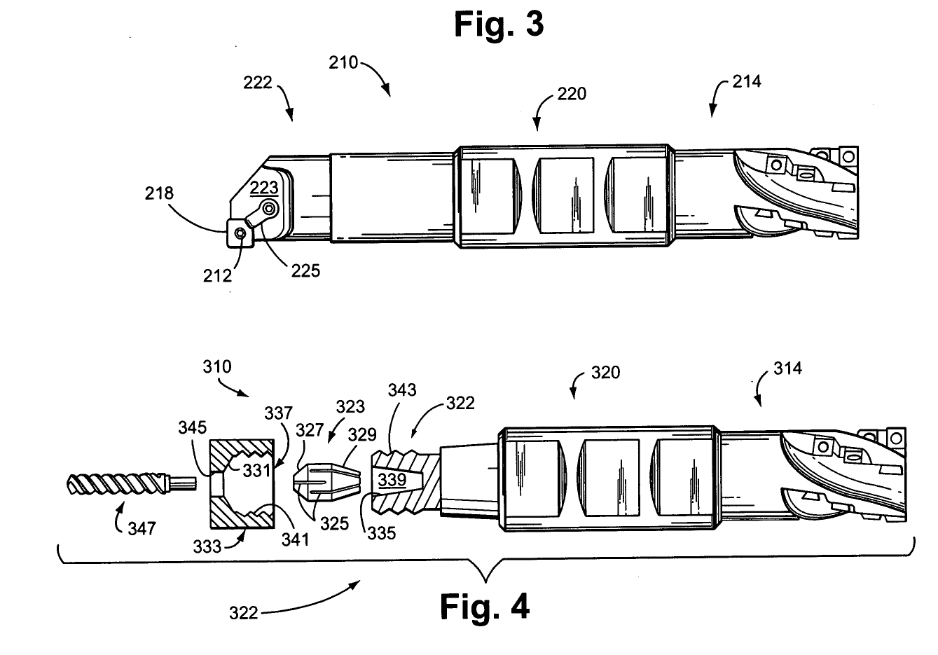

Turning now to FIG. 3, a further embodiment of the invention is shown, wherein cutting tool 210 comprises a first cutting head 214 and a central connector 220, both of which are essentially structurally and functionally similar to cutting head 114 and central connector 120 of the embodiment of FIG. 2. The difference between cutting tool 210 and the prior embodiments of the invention is that second cutting head 222 has structure which is essentially that typical of a boring bar, having an end pocket 223 and a screw-held clamp 225 disposed to hold insert 218 at an apex of the distal end of cutting head 222. Insert 218 is secured not only by clamp 225 but also by screw 212. In this embodiment, there is a central connector 220, a first cutting head 214 having indexable inserts, and a second cutting head 222 having an indexable insert, but of a different arrangement from that of first cutting head 214.

FIG. 4 shows a further embodiment, wherein cutting tool 310 has, just as in the case of cutting tool 210 of FIG. 3, a central connector 320 and a first cutting head 314 which are structurally and functionally similar to cutting head 114 and central connector 120 of the embodiment of FIG. 2. Cutting tool 310 has a second cutting head 322 which is arranged to receive a chuck of any known type which is compatible with this type of tool, such as collet chuck 323. Collet chuck 323 has slots 325 which enable collet chuck to contract or reduce in diameter when subjected to compressive forces. In the embodiment depicted in FIG. 4, collet chuck 323 has a first inclined surface 327 and a second inclined surface 329 which respectively cooperate with a corresponding inclined surface 331 of nut 333 and corresponding inclined surface 335 of second cutting head 322. Collet chuck 323 is received in a chamber formed collectively by a recess 337 formed in nut 333 and a complementing recess 339 formed in second cutting head 322. Collet chuck 323 is conventionally secured to second cutting head 322 by threading nut 333 to second cutting head 322 when female threads 341 of nut 333 engage male threads 343 of second cutting head 322. Nut 333 has a forward opening 345 through which passes the shank of drill 347 to engage collet chuck 323. Thus in the embodiment of FIG. 4, a milling tool having indexable inserts is combined with a drill tool.

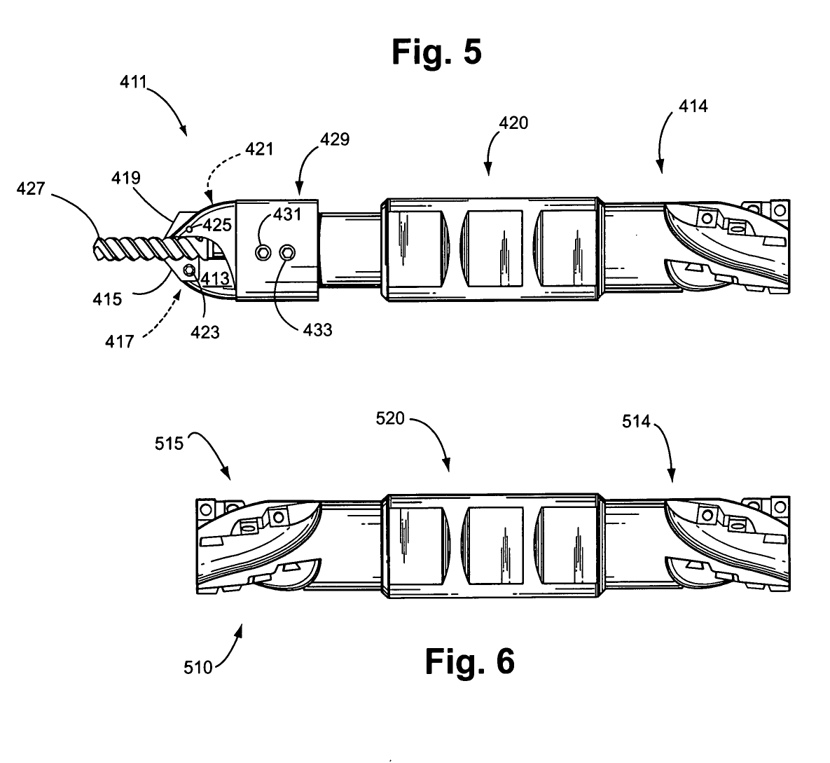

FIG. 5 shows an embodiment of the invention wherein a cutting tool 410 comprises a combination drill counter sink tool 411 at one end, a milling tool 414 having indexable inserts at the other end, and a central connector 420. Milling tool 414 is essentially similar to cutting head 114 of the embodiment of FIG. 2, and similarly, central connector 420 is essentially similar to central connector 120 of the embodiment of FIG. 1. Combination tool 411 has a flute 413 and an insert 415 installed in a pocket 417 formed in flute 413. A second mirror image pocket (not visible in FIG. 5) and a second insert 419 are located in a second flute 421 which is displaced from flute 413 on combination tool 411 by one hundred eighty degrees. Insert 415 is secured within pocket 417 by a screw 423. Insert 419 is similarly secured, although only an end of screw 425 is visible in the view of FIG. 5. A drill 427 is held within body 429 of combination tool 411 by two setscrews 431, 433. Setscrews 431, 433 collectively serve as a retaining element for retaining drill 427 within body 429. Other types of retaining elements may be substituted for setscrews 431, 433. For example, the number of setscrews may be one or more than two. One or more clamps or still other forms (none of these shown) of retaining elements may be provided if desired.

It will be appreciated that drill 427 is a type of tool different from inserts 415 and 419. It is this dissimilarity that defines the subject tool as a combination tool 411. To be a combination type tool, it is merely necessary to have at least two and possibly more dissimilar tools, or tools having a plurality of types of cutting blades, both fixed to the body of the combination tool, such as body 429. It will be seen that of the three bladed cutting tools depicted in FIG. 5, two are similar (inserts 415, 419) and one (drill 427) is different from the first two (inserts 415, 419). Other types of tools may be used to create other combination tools (not shown). For example, inserts which are dissimilar in configuration and cutting characteristics could be provided (this embodiment is not shown). In another example, other types of bladed cutting tools could be provided in place of drill 427 or in place of inserts 415 and 419, or in place of both drill 427 and inserts 415 and 419. Any number of bladed cutting tools and any number of tool types may be provided that there are at least two dissimilar cutting blades mounted to the combination tool.

Turning now to FIG. 6, a further embodiment is shown, wherein cutting heads of different handedness are provided. In the prior embodiments, reversal of the various cutting tools within a machine tool did not require that rotational direction of the machine tool (not shown) be reversed to accommodate the new installation. In the embodiment of FIG. 6, there is presented a cutting tool 510 which reverses rotational direction of the effectiveness of the two cutting heads 514 or 515 depending on which cutting head 514 is arranged to bear on the work piece (not shown). Cutting head 514 is essentially similar to cutting head 114 of the embodiment of FIG. 2, and central connector 520 is essentially similar to central connector 120 of FIG. 2. Cutting head 515, by contrast, shares structural and functional features of cutting head 514, but is formed as a mirror image such that rotational orientation of cutting heads 514 and 515 is opposite. That is, direction of rotation of the machine tool must be reversed from that used for cutting head 514 after cutting head 515 is installed in a position to bear on the work piece. Alternatively stated, one cutting head 514 is configured to bring a cutting edge of each insert disposed thereon with respect to a work piece when cutting tool 510 is rotated in a predetermined rotational direction, and cutting head 515 is configured to bring a cutting edge of each insert disposed thereon to bear on the work piece when cutting tool 510 is rotated in a rotational direction opposite that of the first the predetermined rotational direction. It will be appreciated that the same principle may apply to embodiments of cutting tools (not shown) wherein different types or styles of cutting tools are employed. Illustratively, a cutting tool (not shown) having the different rotational orientations of cutting tool 510 may have a mill type tool such as cutting head 514 at one end, but having a cutting head different from cutting head 515 at the other end. The different cutting head may be a drill, a combination tool, a milling tool with an arrangement of inserts different from that of cutting head 514, or may be of any other cutting characteristic different from that of cutting head 514 in addition to displaying opposite rotational orientation.

In further embodiments, optional features provided in rotary cutting tools may be provided in cutting tools according to the present invention. In one example, cooling passages (not shown) which are utilized to deliver coolants and lubricants to one or more cutting blades may be provided in the body of any cutting tool presented herein.

The documents, patents and patent applications referred to herein are hereby incorporated by reference.

It should be stressed that novelty of the present invention lies in the combination of a two ended rotatable tool at least one end of which receives a repositionable blade such as at least one indexable insert, rather in the particular construction or nature of either one or both of the two cutting ends. Any known rotary cutting, abrading, severing, boring, milling, ramping, plunging, or grinding tool may be placed in opposition to that cutting head or cutting end bearing at least one repositionable cutting element or blade, such as an indexable insert. Such tools may be with or without flutes, may have one or a plurality of blades or inserts, may or may not have at least one blade or insert on both ends, and may differ in the number and arrangement of blades or inserts from one another where blades or inserts are provided for on both ends. The connector of any tool according to the present invention may be discernible from one or both cutting heads, or alternatively may be merely a continuation of one or both cutting heads which is not a discrete member unto itself. Therefore, while the invention has been specifically described in connection with certain specific embodiments thereof, it is to be understood that this is by way of illustration and not of limitation, and the scope of the appended claims should be construed as broadly as the prior art will permit.

1. A cutting tool capable of receiving cutting elements, the cutting tool intended for use with a machine tool having a drive element capable of inducing relative motion between the cutting tool and a work piece, the cutting tool comprising an elongated body having:
a first end section having a first cutting head having at least one seat formed therein for receiving and retaining one replaceable and repositionable cutting element;
a second end section located opposite from the first end section and having a cutting implement including at least one of the group including a cutting blade, a second cutting head having at least one second seat formed therein for receiving and retaining at least one replaceable and repositionable cutting element, and a cutting tool retainer; and
a central connector located between the first end section and the second end section, including an engagement surface disposed to engage the drive element of the machine tool in a manner preventing mutual rotation between the cutting tool and the drive element of the machine tool.

2. A cutting tool capable of receiving cutting inserts, the cutting tool being intended for use with a rotary machine tool having a rotatable drive element capable of rotating the cutting tool relative to a work piece, and comprising an elongated body further comprising:
a first end section having a first cutting head having at least one pocket formed therein for receiving and retaining one indexable insert;
a second end section located oppositely from the first end section and having a cutting implement including at least one of the group including a cutting blade, a second cutting head having at least one second pocket formed therein for receiving and retaining one insert, and a cutting tool retainer; and
a central connector located between the first end section and the second end section, including an engagement surface disposed to engage the rotatable drive element of the machine tool in a manner preventing mutual rotation between the cutting tool and the rotatable drive element of the machine tool.

3. The cutting tool according to claim 2, wherein the first end section has a plurality of pockets formed therein.

4. The cutting tool according to claim 3, wherein the second end section comprises a the second cutting head having a plurality of pockets formed therein.

5. The cutting tool according to claim 2, wherein the first end section has at least one flute, and each the pocket is located within one the flute.

6. The cutting tool according to claim 5, wherein the first end section has a plurality of pockets formed in at least one the flute thereof, and the second end section has a plurality of pockets formed in at least one the flute thereof.

7. The cutting tool according to claim 5, wherein the first end section has a plurality of flutes formed therein and wherein each one of the plurality of flutes has at least one the pocket formed therein, and the second end section has a plurality of flutes formed therein and wherein each one of the plurality of flutes has at least one the pocket formed therein.

8. The cutting tool according to claim 7, wherein every one of the plurality of flutes of the first end section and every one of the plurality of flutes of the second end section has a plurality of the pockets formed therein.

9. The cutting tool according to claim 1, wherein the first end section has a maximum diameter, the second end section has a maximum diameter, and the central connector has an exterior surface having a maximum diameter which is greater in magnitude than both of the maximum diameter of the first end section and the maximum diameter of the second end section, whereby both of the first end section and the second end section of the cutting tool are axially movable through the drive element of the machine tool without making interfering contact with the drive element, and the drive element of the machine can radially close over and retainingly engage the central connector of the cutting tool, thereby enabling reversible installation of the cutting tool within the machine tool.

10. The cutting tool according to claim 9, wherein the engagement surface of the central attachment element comprises at least one flat facet formed in the central attachment element.

11. The cutting tool according to claim 9, wherein the engagement surface of the central attachment element comprises a plurality of flat facets formed in a straight row along the exterior of the central attachment element and spaced apart from each adjacent one of the plurality of flat facets.

12. The cutting tool according to claim 2, further comprising a plurality of indexable inserts, wherein each one of the indexable inserts is dimensioned and configured to be received in at least one of the pockets in a first orientation relative to the at least one of the pockets and also in a second orientation relative to the one of the pockets.

13. The cutting tool according to claim 12, wherein every the pocket includes a fastener configured to captively engage one of the inserts.

14. The cutting tool according to claim 13, wherein the fastener of every the pocket comprises a threaded opening and a screw threadably engageable with one the threaded opening.

15. The cutting tool according to claim 9, wherein the first end section has length, the second end section has length, and the connector has length greater in magnitude than the length of each of the first end section and of the second end section.

16. The cutting tool according to claim 2, wherein the second end section includes a screw held clamp disposed to at least partially engage and retain an insert.

17. The cutting tool according to claim 1, wherein the second end section includes a chuck for receiving a drill.

18. The cutting tool according to claim 17, wherein the chuck is a collet chuck.

19. The cutting tool according to claim 1, wherein the cutting implement of the second end section comprises a combination cutting tool disposed to receive a plurality of types of cutting blades.

20. The cutting tool according to claim 19, wherein the plurality of types of cutting blades include at least one cutting insert and a drill, and wherein the combination cutting tool includes a pocket for receiving each one of the at least one cutting insert, and a retaining element for retaining the drill.

21. The cutting tool according to claim 2, wherein the first cutting head is configured to bring a cutting edge of each the insert to bear on a work piece when the cutting tool is rotated in a predetermined rotational direction, and the second end section is configured to bring a cutting edge of each the cutting implement to bear on a work piece when the cutting tool is rotated in a rotational direction opposite that of the predetermined rotational direction.

22. A cutting tool capable of receiving cutting elements, the cutting tool being intended for use with a machine tool having a drive element capable of inducing relative motion between the cutting tool and a work piece, the cutting tool comprising an elongated body further comprising:
a first end section having a first cutting head having at least one first seat formed therein for receiving and retaining at least one first replaceable cutting element;
a second end section located oppositely from the first end section and having a second cutting head having at least one second seat formed therein for receiving and retaining a second replaceable cutting element; and
a central connector located between the first end section and the second end section, including an engagement surface disposed to engage the drive element of the machine tool in a manner preventing mutual rotation between the cutting tool and the drive element of the machine tool.
